(19) United States
(12) Patent Application Publication
(10) Pub. No.: US 2011/0058082 A1
(43) Pub. Date: Mar. 10, 2011

(54) CMOS Image Sensor with Noise Cancellation

(76) Inventor: Hiok Nam TAY, Singapore (SG)

(21) Appl. No.: 12/945,182

(22) Filed: Nov. 12, 2010

Related U.S. Application Data
(63) Continuation-in-part of application No. 12/534,874, filed on Aug. 4, 2009.
Application No. 12/534,874 is a continuation of application No. 10/868,407, filed on Jun. 14, 2004, now Pat. No. 7,612,817.
Application No. 10/868,407 is a continuation of application No. 10/183,218, filed on Jun. 26, 2002, now Pat. No. 6,795,117.
Application No. 10/183,218 is a continuation-in-part of application No. 11/800,346, filed on May 4, 2007.
Application No. 11/800,346 is a division of application No. 10/236,515, filed on Sep. 6, 2002, now Pat. No. 7,233,350.
(60) Provisional application No. 61/260,609, filed on Nov. 12, 2009.
(60) Provisional application No. 60/345,672, filed on Jan. 5, 2002.
(60) Provisional application No. 60/338,465, filed on Dec. 3, 2001.
(60) Provisional application No. 60/333,216, filed on Nov. 6, 2001.
(60) Provisional application No. 60/345,672, filed on Jan. 5, 2002.
(60) Provisional application No. 60/358,611, filed on Feb. 21, 2002.

(51) Int. Cl. H04N 5/335

(52) U.S. Cl. 348/308; 348/E05.091

(57) ABSTRACT

An image sensor that has one or more pixels within a pixel array coupled to a control circuit and to one or more subtraction circuits. The control circuit may cause each pixel to provide a first reference output signal and a reset output signal and may then cause each pixel to provide a light response output signal and a second reference output signal. The light response output signal corresponds to the image that is to be captured by the sensor. The subtraction circuit may provide a difference between the reset output signal and the first reference output signal to create a noise signal, and may provide a difference between the second reference output signal and the light response output signal to create a normalized light response output signal. The noise signal may then be subtracted from the normalized light response output signal to generate an image signal having reset noise cancelled therefrom.

### CROSS-REFERENCE TO RELATED APPLICATIONS

This application claims priority to U.S. Provisional Patent Application No. 61/260,609 filed on Nov. 12, 2009. This application is also a continuation-in-part of U.S. patent application Ser. No. 12/534,874 filed on Aug. 4, 2009, which is a continuation of U.S. patent application Ser. No. 10/868,407 filed on Jun. 14, 2004, now U.S. Pat. No. 7,612,817, which is a continuation of U.S. patent application Ser. No. 10/183,218 filed on Jun. 26, 2002, now U.S. Pat. No. 6,795,117, which claims priority to U.S. Provisional Patent Application No. 60/345,672 filed on Jan. 5, 2002, to U.S. Provisional Patent Application No. 60/338,465 filed on Dec. 3, 2001, and to U.S. Provisional Patent Application No. 60/333,216 filed on Nov. 6, 2001. This application is also a continuation-in-part of U.S. patent application Ser. No. 11/800,346 filed on May 4, 2007, which is a division of U.S. patent application Ser. No. 10/236,515 filed on Sep. 6, 2002, now U.S. Pat. No. 7,233,350, which claims priority to U.S. Provisional Patent Application No. 60/345,672 filed on Jan. 5, 2002 and to U.S. Provisional Patent Application No. 60/358,611 filed on Feb. 21, 2002.

### BACKGROUND OF THE INVENTION

1. Field of the Invention

The subject matter disclosed generally relates to structures and methods for fabricating solid state image sensors.

2. Background Information

Photographic equipment such as digital cameras and digital camcorders contain electronic image sensors that capture light for processing into a still or video image, respectively. There are two primary types of electronic image sensors, charge coupled devices (CCDs) and complimentary metal oxide semiconductor (CMOS) sensors. CCD image sensors have relatively high signal to noise ratios (SNR) that provide quality images. Additionally, CCDs can be fabricated to have pixel arrays that are relatively small while conforming with most camera and video resolution requirements. A pixel is the smallest discrete element of an image. For these reasons, CCDs are used in most commercially available cameras and camcorders.

CMOS image sensors are faster and consume less power than CCD devices. Additionally, CMOS fabrication processes are used to make many types of integrated circuits. Consequently, there is a greater abundance of manufacturing capacity for CMOS image sensors than CCD sensors. A conventional drawback of CMOS image sensors is the reset noise in image signals from the pixel. The reset noise is caused by thermal noise in a reset transistor being switched off, thus instantaneously sampling the thermal noise onto an internal sensing node of the pixel. Conventional approaches to attenuate the reset noise in CMOS image sensor pixel introduces more devices such as transistors and/or capacitors into each pixel, which makes the pixel larger and therefore is not suitable for multi-millions of pixels.

### BRIEF SUMMARY OF THE INVENTION

An image sensor that has one or more pixels within a pixel array coupled to a control circuit and to one or more subtraction circuits. The control circuit may cause each pixel to provide a first reference output signal and a reset output signal and may then cause each pixel to provide a light response output signal and a second reference output signal. The light response output signal corresponds to the image that is to be captured by the sensor. The subtraction circuit may provide a difference between the reset output signal and the first reference output signal to create a noise signal, and may provide a difference between the second reference output signal and the light response output signal to create a normalized light response output signal. The noise signal may then be subtracted from the normalized light response output signal to generate the a image signal having reset noise cancelled therefrom.

The second reference signal may be different from the first reference signal. In particular, the second reference signal may differ from the first reference signal in the same direction as the reset output signal is from the first reference output signal. This has a beneficial effect of reducing a DC offset in the normalized light response signal.

The subtraction circuit may employ an analog DC cancellation to remove a DC offset in the noise signal. The analog DC cancellation may comprise one or more of the following: (a) a difference of voltage level in a GND1 signal between when the subtraction circuit receives the first reference output signal and when the subtraction circuit receives the reset output signal, (b) a pair of feedback capacitors (between differential inputs and outputs of an amplifier) being charged to a differential voltage level that corresponds to a negative value, and (c) a pair of capacitors precharged to a non-zero differential voltage and subsequently discharged into the pair of feedback capacitors. Other conventional analog DC cancellation methods may be employed.

The control circuit may cause a sensing node of each pixel to have a change in its voltage level to a springboard level after the pixel outputs the first reference output signal and immediately before the pixel outputs the reset output signal, the change being of such direction and magnitude that a DC offset between the first reference output signal and the reset output signal becomes less. In particular, the change may be an increase if the reset transistor is an NFET. Furthermore, the magnitude is preferably such that the difference between the first reference output signal and the reset output signal has a magnitude less than 50 mV.

### BRIEF DESCRIPTION OF THE DRAWINGS

FIG. 1 is a schematic of an embodiment of an image sensor;

FIG. 2 is an illustration of a method for storing pixel data in an external memory for a still image;

FIG. 3 is an illustration of a method for retrieving and combining pixel data for a still image;

FIG. 4 is an illustration of an alternate method for retrieving and combining pixel data;

FIG. 5 is an illustration of alternate method for retrieving and combining pixel data;

FIG. 6 is an illustration of alternate method for retrieving and combining pixel data;

FIG. 7 is an illustration of alternate method for retrieving and combining pixel data;

FIG. 8 is an illustration showing a method for storing and combining pixel data for a video image;

FIG. 9 is another illustration showing the method for storing and combining pixel data for a video image;

FIG. 10 is a diagram showing the levels of a signal across a photodiode of a pixel for a first method of operating the image sensor to form the noise and normalized light response signals;

FIG. 11 is a diagram showing the levels of a signal across a photodiode of a pixel for a second method of operating the image sensor to form the noise and normalized light response signals;

FIG. 12 is a diagram showing the levels of a signal across a photodiode of a pixel and the levels of a GND1 signal in the light reader for a third method of operating the image sensor to form the noise and normalized light response signals;

FIG. 13 is a schematic of an embodiment of a pixel of the image sensor;

FIG. 14 is a schematic of an embodiment of a light reader circuit of the image sensor.

FIG. 15 is a flowchart for an operation of the image sensor;

FIG. 16 is a timing diagram for the first method of operating the image sensor;

FIG. 17 is a timing diagram for the second method of operating the image sensor;

FIG. 18 is a schematic for a logic circuit for generating the timing diagrams of FIG. 16;

FIG. 19 is a schematic of a logic circuit for generating a RST signal for a row of pixels;

FIG. 20 is a timing diagram for the logic circuit shown in FIG. 19;

FIG. 21 is a schematic for a logic circuit for generating the timing diagrams of FIG. 17;

FIG. 22 is a timing diagram for the third method of operating the image sensor;

FIG. 23 is a schematic for a logic circuit for generating the timing diagrams of FIG. 22.

### DETAILED DESCRIPTION

Disclosed is an image sensor within a pixel array. The pixel array may be coupled to a control circuit and subtraction circuits. The control circuit may cause each pixel to provide a first reference output signal and a reset output signal. The control circuit may then cause each pixel to provide a light response output signal and a second reference output signal. The light response output signal corresponds to the image that is to be captured by the sensor.

The subtraction circuit may provide a difference between the reset output signal and the first reference output signal to create a noise signal that is stored in an external memory. The subtraction circuit may also provide a difference between the light response output signal and the second reference output signal to create a normalized light response output signal. The noise signal is retrieved from memory and combined with the normalized light response output signal to generate the output data of the sensor. The image sensor contains image buffers that allow the noise signal to be stored and then retrieved from memory for the subtraction process. The image sensor may further have a memory controller and/or a data interface that transfers the data to an external device in an interleaving manner.

The pixel may be a three transistor structure that minimizes the pixel pitch of the image sensor. The entire image sensor is preferably constructed with CMOS fabrication processes and circuits. The CMOS image sensor has the characteristics of being high speed, low power consumption, small pixel pitch and a high SNR.

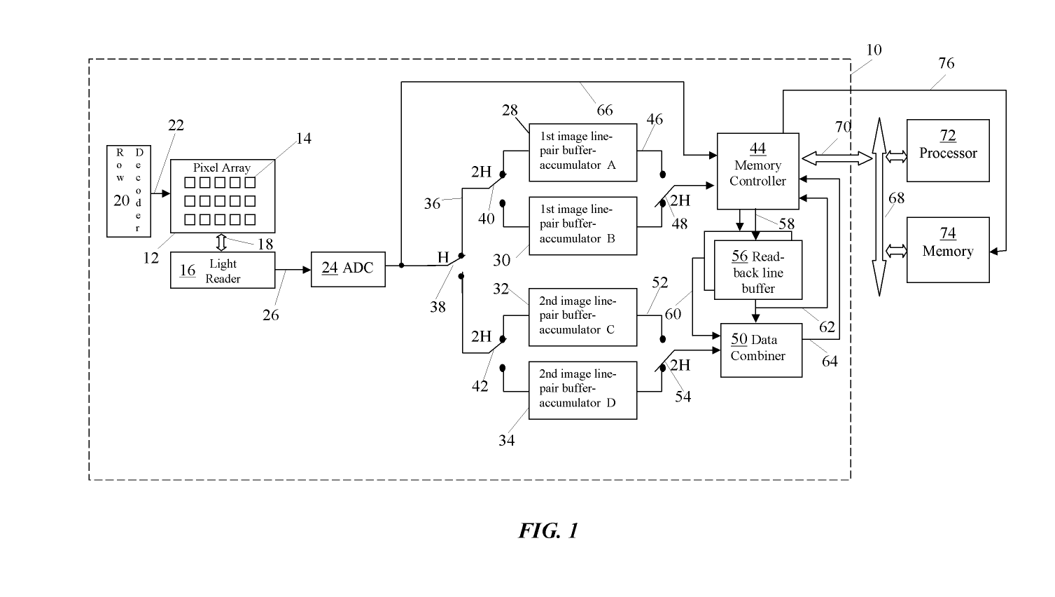

Referring to the drawings more particularly by reference numbers, FIG. 1 shows an image sensor 10. The image sensor 10 includes a pixel array 12 that contains a plurality of individual photodetecting pixels 14. The pixels 14 are arranged in a two-dimensional array of rows and columns.

The pixel array 12 is coupled to a light reader circuit 16 by a bus 18 and to a row decoder 20 by control lines 22. The row decoder 20 can select an individual row of the pixel array 12. The light reader 16 can then read specific discrete columns within the selected row. Together, the row decoder 20 and the light reader 16 allow for the reading of an individual pixel 14 in the array 12.

The light reader 16 may be coupled to an analog to digital converter 24 (ADC) by output line(s) 26. The ADC 24 generates a digital bit string that corresponds to the amplitude of the signal provided by the light reader 16 and the selected pixels 14.

The ADC 24 is coupled to a pair of first image buffers 28 and 30, and a pair of second image buffers 32 and 34 by lines 36 and switches 38, 40 and 42 . The first image buffers 28 and 30 are coupled to a memory controller 44 by lines 46 and a switch 48. The memory controller 44 can more generally be referred to as a data interface. The second image buffers 32 and 34 are coupled to a data combiner 50 by lines 52 and a switch 54. The memory controller 44 and data combiner 50 are connected to a read back buffer 56 by lines 58 and 60, respectively. The output of the read back buffer 56 is connected to the controller 44 by line 62. The data combiner 50 is connected to the memory controller 44 by line 64. Additionally, the controller 44 is connected to the ADC 24 by line 66.

The memory controller 44 is coupled to an external bus 68 by a controller bus 70. The external bus 68 is coupled to an external processor 72 and external memory 74. The bus 70, processor 72 and memory 74 are typically found in existing digital cameras, cameras and cell phones.

To capture a still picture image, the light reader 16 retrieves a first image of the picture from the pixel array 12 line by line. The switch 38 is in a state that connects the ADC 24 to the first image buffers 28 and 30. Switches 40 and 48 are set so that data is entering one buffer 28 or 30 and being retrieved from the other buffer 30 or 28 by the memory controller 44. For example, the second line of the pixel may be stored in buffer 30 while the first line of pixel data is being retrieved from buffer 28 by the memory controller 44 and stored in the external memory 74.

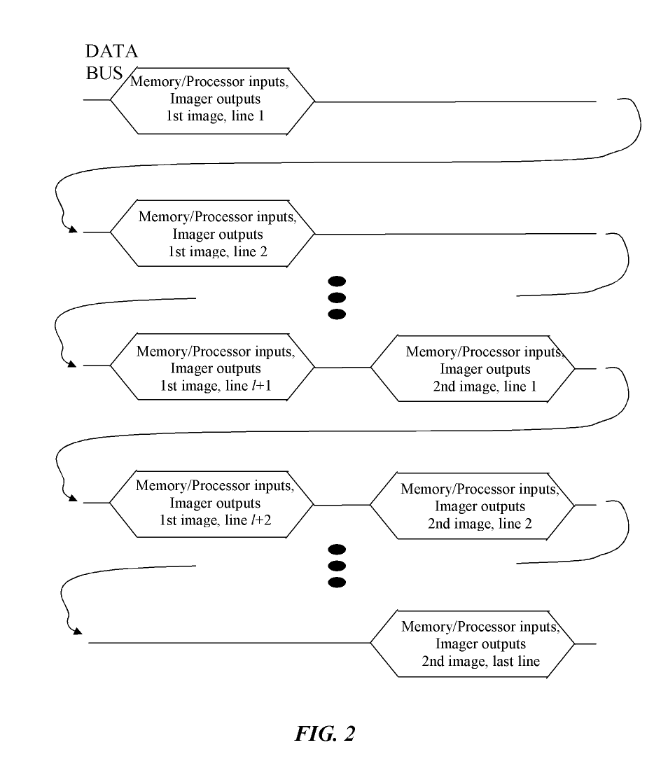

When the first line of the second image of the picture is available the switch 38 is selected to alternately store first image data and second image data in the first 28 and 30, and second 32 and 34 image buffers, respectively. Switches 48 and 54 may be selected to alternatively store first and second image data into the external memory 74 in an interleaving manner. This process is depicted in FIG. 2.

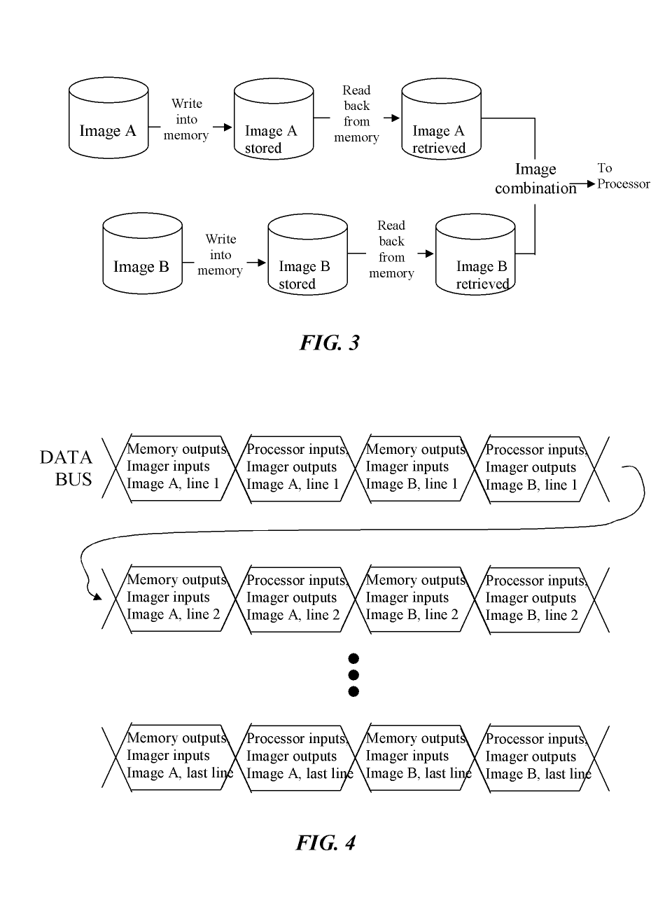

There are multiple methods for retrieving and combining the first and second image data. As shown in FIG. 3, in one method each line of the first and second images are retrieved from the external memory 74 at the memory data rate, stored in the read back buffer 56, combined in the data combiner 50 and transmitted to the processor 72 at the processor data rate. Alternatively, the first and second images may be stored in the read back buffer 56 and then provided to the processor 72 in an interleaving or concatenating manner without combining the images in the combiner 50. This technique allows the processor 72 to process the data manner in different ways.

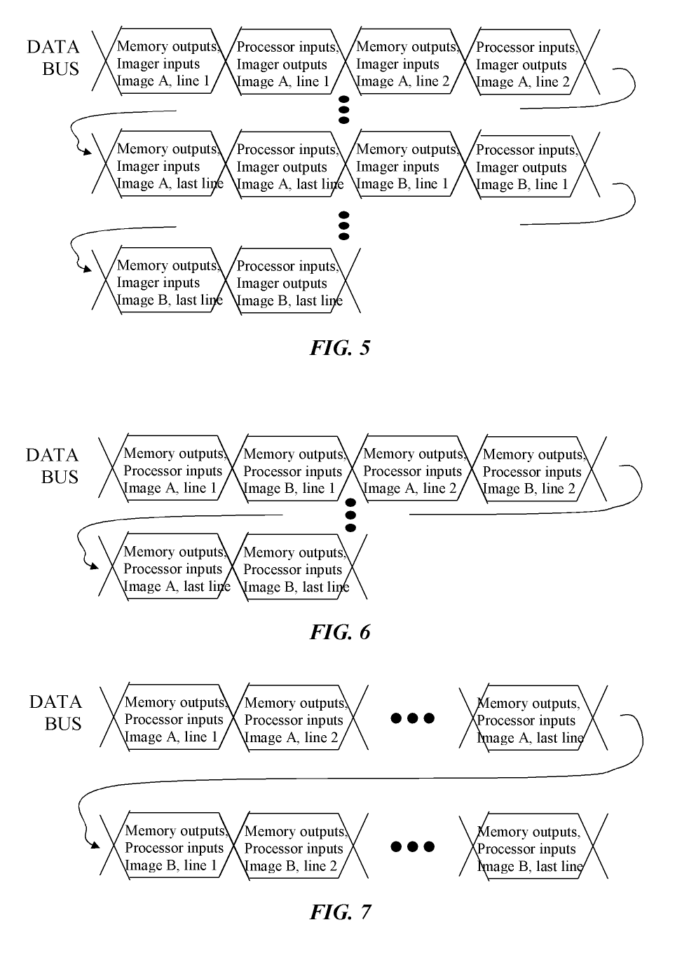

FIG. 4 shows an alternative method wherein the external processor 72 combines the pixel data. A line of the first image is retrieved from the external memory 74 and stored in the read back buffer 56 at the memory data rate and then transferred to the external processor 72 at the processor data rate. A line of the second image is then retrieved from the external memory 74, stored in the read back buffer 56 , and transferred to the external processor 72. This sequence continues for each line of the first and second images. Alternatively, the entire first image may be retrieved from the external memory 74, stored in the read back buffer 56 and transferred to the external processor 72, one line at a time, as shown in FIG. 5. Each line of the second image is then retrieved from the external memory 74, stored in the read back buffer 56 and transferred to the external processor 72.

In the event the processor data rate is the same as the memory data rate the processor 72 may directly retrieve the pixel data rate from the external memory 74 in either an interleaving or concatenating manner as shown in FIGS. 6 and 7, respectively. For all of the techniques described, the memory controller 44 provides arbitration for data transfer between the image sensor 10, the processor 72 and memory 74. To reduce noise in the image sensor 10, the controller 44 preferably transfers data when the light reader 16 is not retrieving output signals.

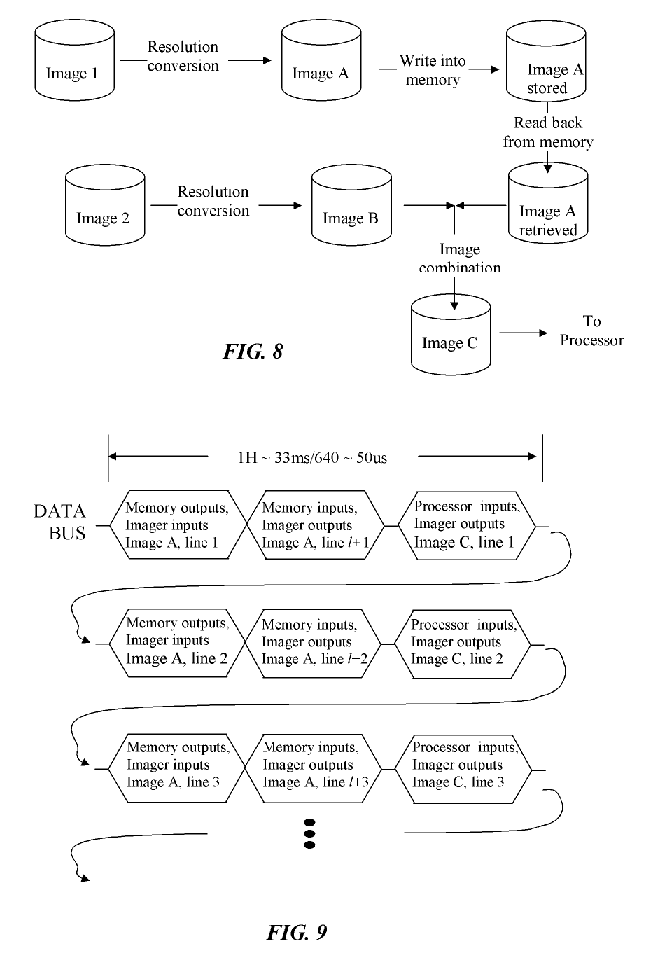

To capture a video picture, the lines of pixel data of the first image of the picture may be stored in the external memory 74. When the first line of the second image of the picture is available, the first line of the first image is retrieved from memory 74 at the memory data rate and combined in the data combiner 50 as shown in FIGS. 8 and 9. The combined data is transferred to the external processor 72 at the processor data rate. As shown in FIG. 9, the external memory is both outputting and inputting lines of pixel data from the first image at the memory data rate.

For video capture the buffers 28, 30, 32 and 34 may perform a resolution conversion of the incoming pixel data.

There are two common video standards NTSC and PAL. NTSC requires 480 horizontal lines. PAL requires 590 horizontal lines. To provide high still image resolution the pixel array 12 may contain up to 1500 horizontal lines. The image sensor converts the output data into a standard format.

Converting resolution onboard the image sensor reduces the overhead on the processor 72.

To conserve energy the memory controller 44 may power down the external memory 74 when memory is not receiving or transmitting data. To achieve this function the controller 44 may have a power control pin 76 connected to the CKE pin of a SDRAM (see FIG. 1).

FIG. 13 shows an embodiment of a cell structure for a pixel 14 of the pixel array 12. The pixel 14 may contain a photodetector 100. By way of example, the photodetector 100 may be a photodiode. The photodetector 100 may be connected to a reset transistor 112. The photodetector 100 may also be coupled to a select transistor 114 through a level shifting transistor 116. The transistors 112, 114 and 116 may be field effect transistors (FETs).

The gate of reset transistor 112 may be connected to a RST line 118. The drain node of the transistor 112 may be connected to IN line 120. The gate of select transistor 114 may be connected to a SEL line 122. The source node of transistor 114 may be connected to an OUT line 124. The RST 118 and SEL lines 122 may be common for an entire row of pixels in the pixel array 12. Likewise, the IN 120 and OUT 124 lines may be common for an entire column of pixels in the pixel array 12. The RST line 118 and SEL line 122 are connected to the row decoder 20 and are part of the control lines 22.

The IN line 120 may be driven by a supply driver 17. Supply driver 17 can be programmed to drive one of a number of voltage levels. By way of example, the supply driver 17 may drive up to four difference voltage levels, in increasing order, 0 volt, VPH2, VPH1 and VPH0, selectable by signal DIN(1:0) value of 00, 01, 10 and 11, respectively. For example, VPH2 may be 2.3 volts, VPH1 2.5 volts and VPH0 2.7 volts.

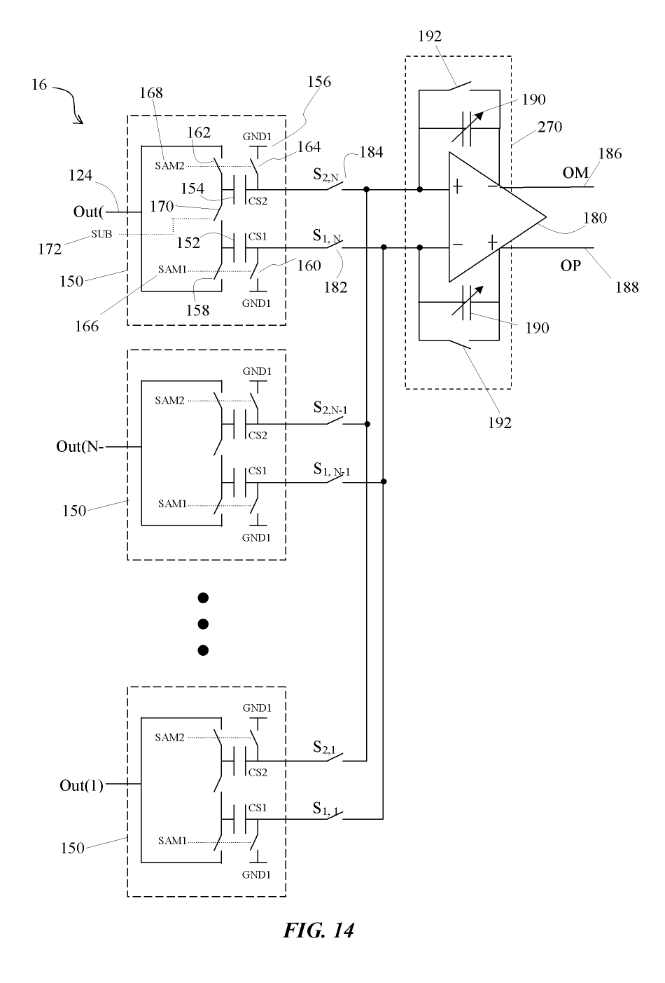

FIG. 14 shows an embodiment of a light reader circuit 16. The light reader 16 may include a plurality of double sampling capacitor circuits 150 each connected to an OUT line 124 of the pixel array 12. Each double sampling circuit 150 may include a first capacitor 152 and a second capacitor 154. The first capacitor 152 is coupled to the OUT line 124 and ground GND1 156 by switches 158 and 160, respectively. The second capacitor 154 is coupled to the OUT line 124 and ground GND 1 by switches 162 and 164, respectively. Switches 158 and 160 are controlled by a control line SAM1 166. Switches 162 and 164 are controlled by a control line SAM2 168. The capacitors 152 and 154 can be connected together to perform a voltage subtraction by closing switch 170. The switch 170 is controlled by a control line SUB 172.

The double sampling circuits 150 are connected to an operational amplifier 180 by a plurality of first switches 182 and a plurality of second switches 184. The amplifier 180 has a negative terminal−coupled to the first capacitors 152 by the first switches 182 and a positive terminal+coupled to the second capacitors 154 by the second switches 184. The operational amplifier 180 has a positive output+connected to an output line OP 188 and a negative output−connected to an output line OM 186. The output lines 186 and 188 are connected to the ADC 24 (see FIG. 1).

The operational amplifier 180 provides an amplified signal that is the difference between the voltage stored in the first capacitor 152 and the voltage stored in the second capacitor 154 of a sampling circuit 150 connected to the amplifier 180. The gain of the amplifier 180 can be varied by adjusting the variable capacitors 190. The variable capacitors 190 may be discharged by closing a pair of switches 192. The switches 192 may be connected to a corresponding control line (not shown). Although a single amplifier is shown and described, it is to be understood that more than one amplifier can be used in the light reader circuit 16.

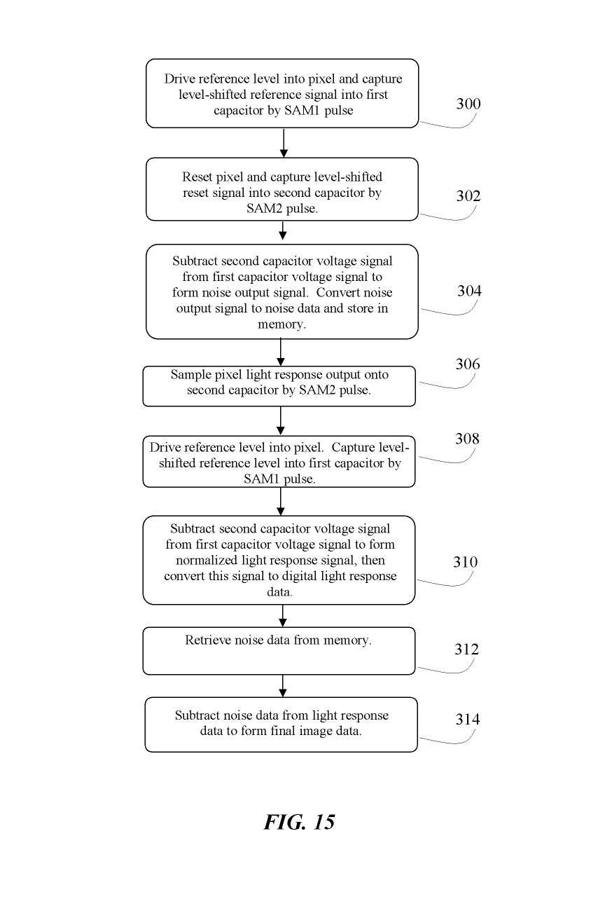

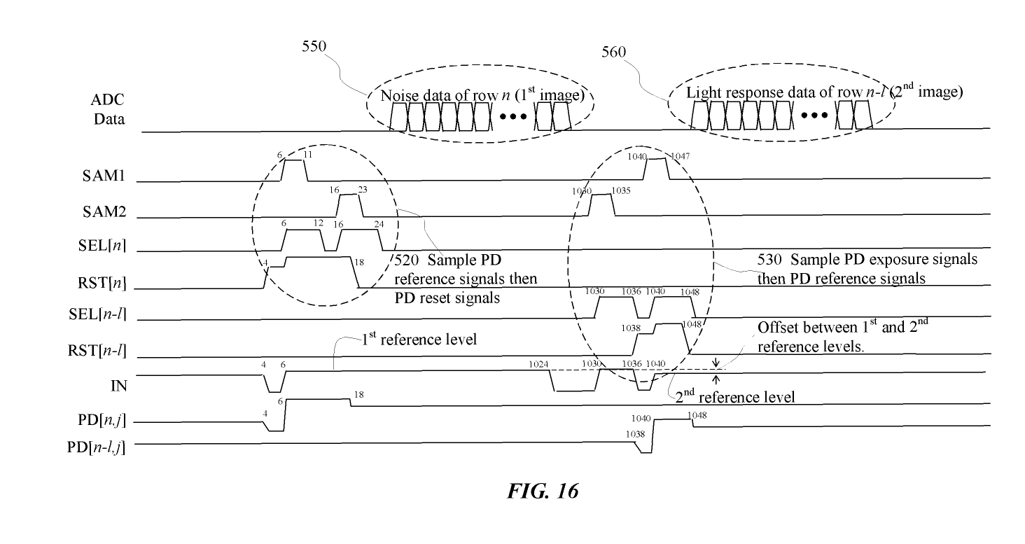

FIGS. 15 and 16 show an operation of the image sensor 10. In process block 300 a first reference signal is written into each pixel 14 of the pixel array and then a first reference output signal is stored in the light reader 16. Referring to FIGS. 13 and 16, this can be accomplished by switching the RST 118 and IN 120 lines from a low voltage to a high voltage to turn on the reset transistor 112. The RST line 118 is driven high for an entire row. IN line 120 is driven high for an entire column by switching DIN(1:0) to “10” to select VPH1 level as the first reference signal. By way of example, RST line 118 is first driven high while the IN line 120 is initially low, by switching DIN(1:0) to “00” to select 0 Volt. This causes the reset transistor 112 to enter the triode region. In the triode region the voltage across the photodiode 100 is approximately same as the voltage on the IN line 120.

The RST line 118 may be connected to a tri-state buffer (not shown) that is switched to a tri-state when the IN line 120 is switched to a high state. This allows the gate voltage to float to a value that is higher than the voltage on the IN line 120. This maintains the reset transistor 112 in the triode region. Generating a higher gate voltage allows the photodetector to be reset at a level close to a supply voltage on the image sensor.

The SEL line 122 is also switched to a high voltage level which turns on select transistor 114. The voltage of the photodiode 100 is provided to the OUT line 124 through level shifter transistor 116 and select transistor 114. The SAM1 control line 166 of the light reader 16 (see FIG. 14) is selected so that the voltage on the OUT line 124 is stored in the first capacitor 152.

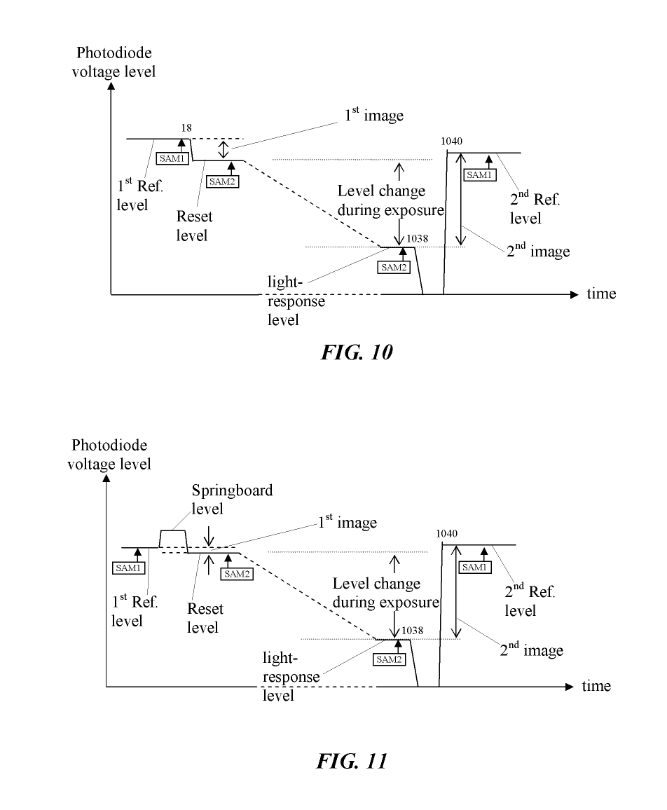

Referring to FIG. 15, in process block 302 the pixels of the pixel array are reset and reset output signals are then stored in the light reader 16. Referring to FIGS. 13 and 16, this can be accomplished by driving the RST line 118 low to turn off the transistor 112 and reset the pixel 14. Turning off the transistor 112 will create reset noise, charge injection and clock feed-through voltage that resides across the photodiode 100. As shown in FIG. 10 the noise reduces the voltage at the photodetector 100 when the reset transistor 112 is reset.

The SAM2 line 168 is driven high, the SEL line 122 is driven low and then high again, so that a level-shifted voltage of the photodiode 100 is stored as a reset output signal in the second capacitor 154 of the light reader circuit 16. Process blocks 300 and 302 are repeated for each pixel 14 in the array 12.

Referring to FIG. 15, in process block 304 the reset output signals are then subtracted from the first reference output signals to create noise output signals that are then converted to digital bit strings by ADC 24. The digital output data is stored within the external memory 74 in accordance with one of the techniques described in FIG. 2, 3, 8 or 9. The noise signals correspond to the first image pixel data. Referring to FIG. 14, the subtraction process can be accomplished by closing switches 182, 184 and 170 of the light reader circuit 16 (FIG. 14) to subtract the voltage across the second capacitor 154 from the voltage across the first capacitor 152.

Referring to FIG. 15, in block 306 light response output signals are sampled from the pixels 14 of the pixel array 12 and stored in the light reader circuit 16. The light response output signals correspond to the optical image that is being detected by the image sensor 10. Referring to FIGS. 13, 14 and 16 this can be accomplished by having the IN 120, SEL 122 and SAM2 lines 168 in a high state and RST 118 in a low state. The second capacitor 152 of the light reader circuit 16 stores a level shifted voltage of the photodiode 100 as the light response output signal.

Referring to FIG. 15, in block 308 a second reference output signal is then generated in the pixels 14 and stored in the light reader circuit 16. Referring to FIGS. 13, 14 and 16, this can be accomplished similar to generating and storing the first reference output signal. The RST line 118 is first driven high and then into a tri-state. The IN line 120 is then driven high to a second reference level to cause the transistor 112 to enter the triode region so that the voltage across the photodiode 100 is the voltage on IN line 120. The SEL 122 and SAM2 168 lines are then driven high to store the second reference output voltage in the first capacitor 154 of the light reader circuit 16. The second reference level may be different from the first reference level. By way of example, the second reference level may be the VPH2 level, selected by switch DIN(1:0) to “01”. The second reference level may be chosen to be offset from the first reference level in a same direction as the reset level is offset from the first reference level and by a similar amount, for example by such amount that the second reference output signal level on the OUT line is within 50 mV of the reset output signal. Having the second reference level taking such an offset has a benefit of minimizing a DC offset in the light response output signal (described in the next paragraph), as such DC offset under high gain can saturate the amplifier 180 in the light reader 16. The reference offset may be chosen to be between 50 mV to 300 mV, preferably 150 mV. A reference offset in the noise signal due to the offset between the first and second references may be removed subsequently in the digital domain within the combiner 50 or in the external processor 72. Alternately, the reference offset in the noise signal may be removed in the analog domain prior to digitizing by the ADC 24 by any one of the methods known in the art. Process blocks 306 and 308 are repeated for each pixel 14 in the array 12.

Referring to FIG. 15, in block 310 the light response output signal is subtracted from the second reference output signal to create a normalized light response output signal. The normalized light response output signal is converted into a digital bit string to create normalized light output data that is stored in the second image buffers 32 and 34. The normalized light response output signals correspond to the second image pixel data. Referring to FIGS. 13, 14 and 16 the subtraction process can be accomplished by closing switches 170, 182 and 184 of the light reader 16 to subtract the voltage across the first capacitor 152 from the voltage across the second capacitor 154. The difference is then amplified by amplifier 180 and converted into a digital bit string by ADC 24 as light response data.

Referring to FIG. 15, in block 312 the noise data is retrieved from external memory. In block 314 the noise data is combined (subtracted) with the normalized light output data in accordance with one of the techniques shown in FIG. 3, 4, 5, 6, 7 or 8. The noise data corresponds to the first image and the normalized light output data corresponds to the second image. The present technique subtracts the noise data, due to reset noise, charge injection and clock feedthrough, from the normalized light response signal. This improves the signal to noise ratio of the final image data. The image sensor performs this noise cancellation with a pixel that has only three transistor. This image sensor thus provides noise cancellation while maintaining a relatively small pixel pitch. This process is accomplished using an external processor 72 and external memory 74. As aforementioned, the reference offset in the noise signal due to the offset between the first and second references may be removed in the digital domain within the combiner 50 or in the external processor 72. Alternately, the reference offset in the noise signal may be removed in the analog domain prior to digitizing by the ADC 24 by any one of the methods known in the art.

The process described is performed in a sequence across the various rows of the pixels in the pixel array 12. As shown in FIG. 16, the n-th row in the pixel array may be generating noise signals while the n-l-th row generates normalized light response signals, where l is the exposure duration in multiples of a line period.

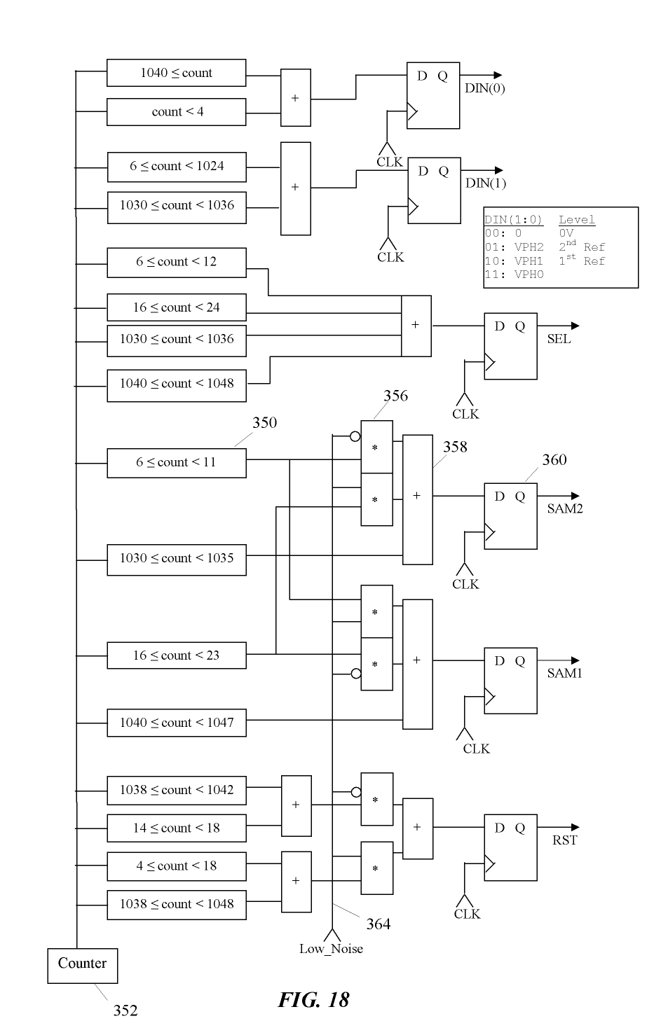

The various control signals RST, SEL, DIN(1:0), SAM1, SAM2 and SUB can be generated in the circuit generally referred to as the row decoder 20. FIG. 18 shows an embodiment of logic to generate the DIN(1:0), SEL, SAM1, SAM2 and RST signals in accordance with the timing diagram of FIG. 16. The logic may include a plurality of comparators 350 with one input connected to a counter 352 and another input connected to hardwired signals that contain a lower count value and an upper count value. The counter 352 sequentially generates a count. The comparators 350 compare the present count with the lower and upper count values. If the present count is between the lower and upper count values the comparators 350 output a logical 1.

The comparators 350 are connected to plurality of AND gates 356 and OR gates 358. The OR gates 358 are connected to latches 360. The latches 360 provide the corresponding DIN(1:0), SEL, SAM1, SAM2 and RST signals. The AND gates 356 are also connected to a mode line 364. To operate in accordance with the timing diagram shown in FIG. 16, the mode line 364 is set at a logic 1.

The latches 360 switch between a logic 0 and a logic 1 in accordance with the logic established by the AND gates 356, OR gates 358, comparators 350 and the present count of the counter 352. For example, the hardwired signals for the comparator coupled to the DIN(1) latch may contain a count values of 6 and a count value of 1024. If the count from the counter is greater or equal to 6 but less than 1024 the comparator 350 will provide a logic 1 that will cause the DIN(1) latch 360 to output a logic 1. The lower and upper count values establish the sequence and duration of the pulses shown in FIG. 16.

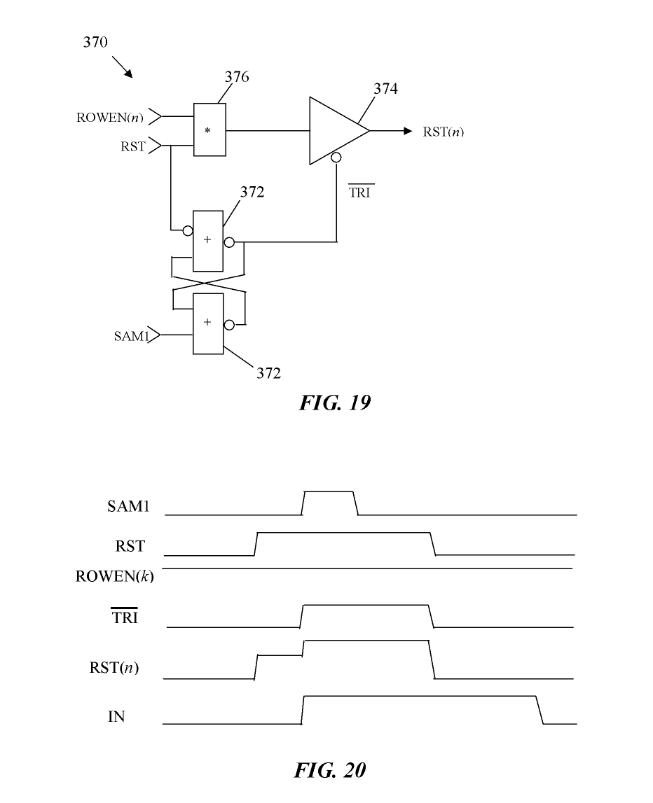

The sensor 10 may have a plurality of reset RST(n) drivers 370, each driver 370 being connected to a row of pixels. FIGS. 19 and 20 show an exemplary driver circuit 370 and the operation of the circuit 370. Each driver 370 may have a pair of NOR gates 372 that are connected to the RST and SAM1 latches shown in FIG. 18. The NOR gates control the state of a tri-state buffer 374. The tri-state buffer 374 is connected to the reset transistors in a row of pixels. The input of the tri-state buffer is connected to an AND gate 376 that is connected to the RST latch and a row enable ROWEN(n) line.

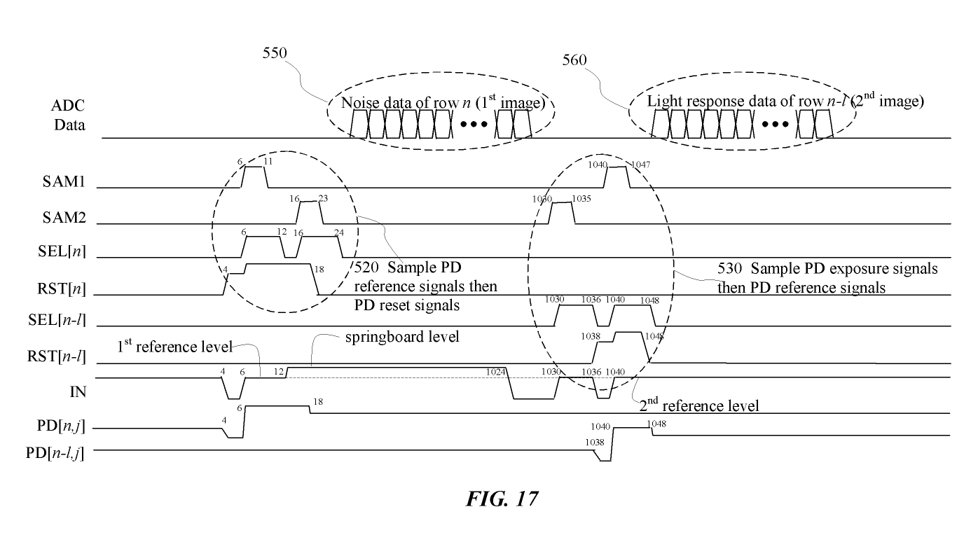

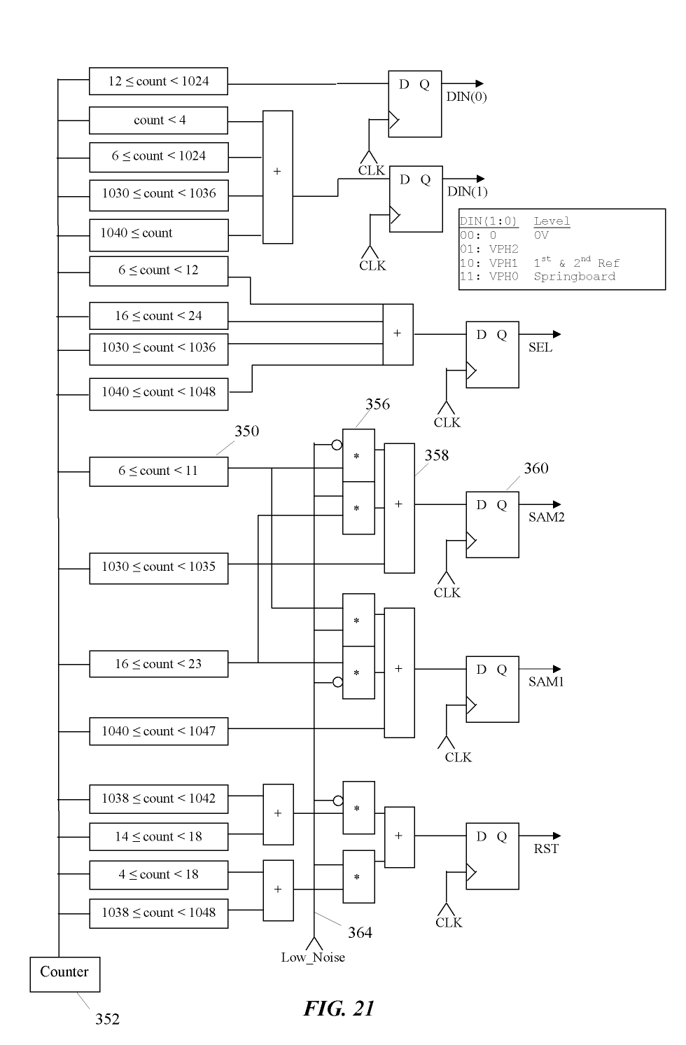

FIG. 17 shows a timing diagram for a second method for operating the image sensor to form the noise and normalized light response signals. FIG. 11 shows the corresponding photodiode voltage changes. In the second method, the IN line 120 is driven to a higher springboard level than the first reference level as shown in FIG. 11 after the first reference output signal is sampled in step 300 and before step 302, by switching DIN(1:0) to “11” to select the VPHO level. The offset of the springboard level above the first reference level (hereinafter “springboard offset”) can in part cancel the photodiode voltage drop during the reset in step 302, so that the offset between the first reference level and the reset level (hereinafter “reset offset”), and concomitantly a DC offset in the noise signal, is reduced. The springboard offset may be between 50 mV to 300 mV, preferably 150 mV. In this method, the second reference level may be same as the first reference level, since the photodiode reset level is brought essentially close to the first reference level, such as within 50 mV, so that a DC offset in the normalized light response signal is likewise reduced when the second reference level is the first reference level, which is VPH1, selected by DIN(1:0)=“10”, as shown in FIG. 21. Alternatively, the second reference level may be selected to be different from the first reference level in conjunction with use of the springboard level to cancel a DC offset in the noise signal and/or the normalized light response signal.

FIG. 21 shows a second embodiment of logic to generate the DIN(1:0), SEL, SAM1, SAM2 and RST signals in accordance with the timing diagram of FIG. 17.

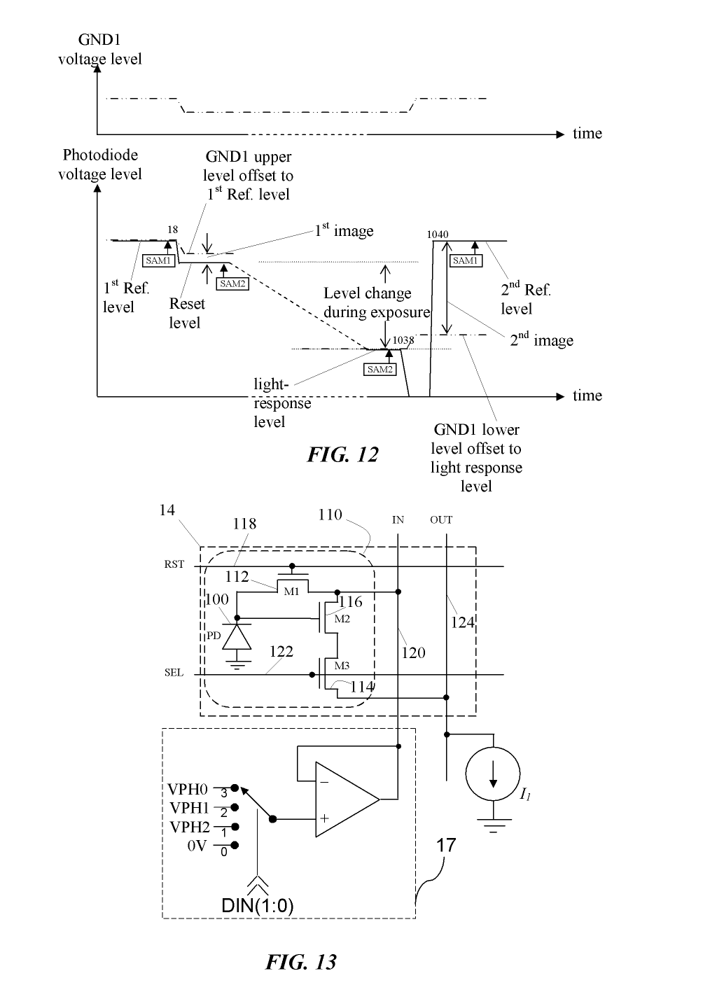

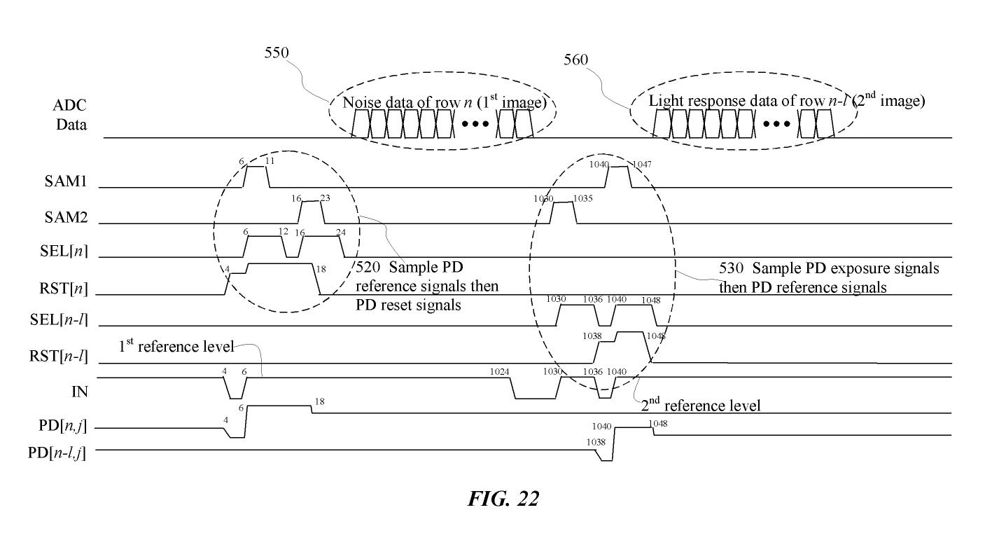

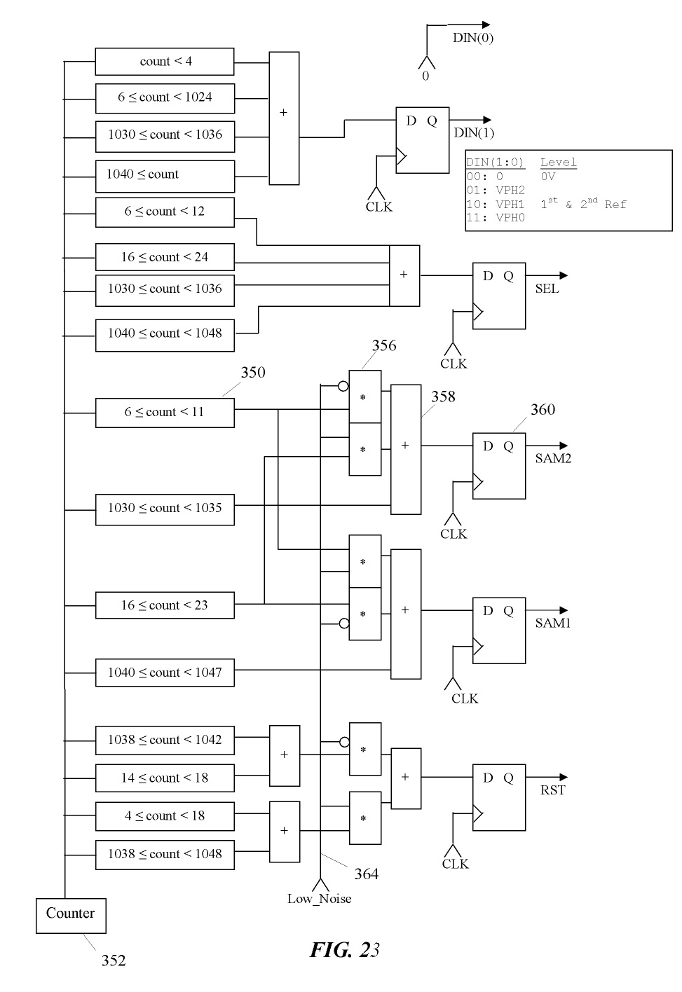

FIG. 22 shows a timing diagram for a third method of operating the image sensor. FIG. 12 shows the corresponding photodiode voltage changes. In the third method, the GND1 signal 156 in the light reader 16 (see FIG. 14) that connects to the capacitors 152, 154 has a voltage that varies between a first GND1 level and a second GND1 level, the difference (hereinafter “GND1 step”) between 50 mV and 300 mV, inclusive. The second GND1 level is offset from the first GND1 level in the same direction as the photodiode reset level is offset from the first reference level, as shown in FIG. 12, or equivalents in the same direction as the reset output signal level is offset from the first reference output signal level. The GND1 signal 156 takes the second GND1 level during samplings of the reset output signal and the light response output signal, whereas during samplings of the first and second reference output signal it takes the first GND1 level. The GND1 step thus at least partially cancels the offset between the reset level and the first reference level and, concomitantly also the offset between the light response level and the second reference level. Preferably, the GND1 step is within 50 mV of the step from the first reference output signal down to the reset output signal level. The second reference level may be same as the first reference level, for example the VPH1 level, selected by DIN(1:0)=“10”, as shown in FIG. 23. Alternatively, the second reference level may be selected to be different from the first reference level in conjunction with using the springboard level and/or the GND1 step to cancel DC offset in the noise signal and/or the normalized light response output signal. For example, during samplings of the light response output signal and the second reference output signal, the GND1 may take the second GND1 level (or the first GND1 level) and the second reference output signal level differs from the first reference output signal level, such as to be within 50 mV of the reset output signal level. An analog signal driver for the GND1 signal 156 has multiple output level, selectable by a digital input, similar to that for the IN line driver 17, and may be controlled by a logic circuit using a similar technique of construction like the logic circuit for generating the DIN(1:0) signals.

FIG. 23 shows a third embodiment of logic to generate the DIN(1:0), SEL, SAM1, SAM2 and RST signals in accordance with the timing diagram of FIG. 22.

The third method essentially uses a technique of analog offset cancellation in the light reader 16. Different variations on analog offset cancellation are possible, as is known in the art. In one alternative, instead of varying the GND1 signal 156, a pair of cancelling capacitors (not shown) may be connected to the “+” and “−” inputs of the amplifier 180 to perform the analog offset cancellation. These cancelling capacitors can be charged to given voltages, their capacitances may be the same as sampling capacitors 152, 154 or different. Each time a sampling circuit 150 of the light reader 16 is connected to the amplifier 180 to transfer charges, the cancelling capacitors are also charged to the given voltages and subsequently connected to transfer charges to the feedback capacitors 190 to effect the offset cancellation.

Yet another technique is to precharge the feedback capacitors 190 to a suitable differential voltage (hereinafter “precharge voltage”) prior to each transfer of charges from a sampling circuit 150. The precharge voltage has an opposite direction than the reset offset in the sense that the precharge voltage partially cancels an output change of the amplifier 180 due to the reset offset. The precharge voltage may be increased in magnitude for an increase in gain of the amplifier 270 (i.e. the amplifier 180 together with the feedback capacitors 190) when the feedback capacitors 190 take a smaller capacitance value.

It is the intention of the inventor that only claims which contain the term “means” shall be construed under 35 U.S.C. §112, sixth paragraph.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

For example, one or more of the first, second and third methods may be used in conjunction to achieve lesser DC offset in the noise signal and/or in the normalized light response output signal.

For example, to reduce DC offset in the normalized light response output signal, the second reference level is different than the first reference level and/or the GND1 level upon sampling the second reference output signal is different from the GND1 level upon sampling the light response output signal level (or any analog offset cancellation method deployed in the light reader 16) and/or the springboard level is driven onto the photodiode between the first reference level and the reset level. Preferably, one of these alone or two or more of these together are selected to be such that the differential output of the amplifier 270 changes less than 200 mV at a gain above 4 under a condition that the pixel is not exposed to light and exposure time is less than 10 ms. Alternatively, the voltage across the capacitor that samples and stores the light response output signal should be within 50 mV of the voltage across the capacitor that samples and stores the second reference output signal under this condition.

For example, although interleaving techniques involving entire lines of an image are shown and described, it is to be understood that the data may be interleaved in a manner that involves less than a full line, or more than one line. By way of example, one-half of the first line of image A may be transferred, followed by one-half of the first line of image B, followed by the second-half of the first line of image A, and so forth and so on. Likewise, the first two lines of image A may be transferred, followed by the first two lines of image B, followed by the third and fourth lines of image A, and so forth and so on.

What is claimed is:

1. An image sensor, comprising:
a photodetector;
an output transistor having a gate coupled to receive a signal from said photodetector;
a reset transistor having a source terminal coupled to reset said photodetector;
a sample circuit coupled to receive an output signal from said output transistor, said sample circuit includes a first capacitor that has a first terminal and a second terminal and a second capacitor that has a third terminal and a fourth terminal, the first and third terminals being respectively connected to receive signal from said output transistor, the second and fourth terminals being respectively connected to a GND1 signal; and,
a control circuit having a configuration to switch said reset transistor to a triode region such that said output transistor provides a sampled first reference output signal to the first terminal and to subsequently switch said reset transistor to an OFF state such that said output transistor provides a sampled reset output signal that has a voltage different from a voltage of said sampled first reference output signal to the third terminal and a configuration to switch said sample circuit to sample and store said sampled first reference output signal on the first capacitor when said reset transistor is in said triode region and to sample and store said sampled reset output signal on the second capacitor when said reset transistor is in said OFF state, said control circuit also selects a first GND1 level for the GND1 signal to sample and store said sampled first reference output signal and selects a second GND1 level for the GND1 signal to sample and store said sample reset output signal, the first GND1 level being higher than the second GND1 level.

2. The image sensor of claim 1, wherein the first GND1 level is above the second GND1 level to within 50 mV of how much the first reference output signal is above the reset output signal in terms of voltage level.

3. The image sensor of claim 1, wherein said control circuit has a configuration to switch said output transistor to provide a sampled light response output signal and to subsequently switch said reset transistor into a triode region such that said output transistor provides a sampled second reference output signal and a configuration to switch said sample circuit to sample and store said sampled light response output signal and to sample and store said sampled second reference output signal, said control circuit also selects a third GND1 level for the GND1 signal to sample and store said sampled light response output signal and selects a fourth GND1 level for the GND1 signal to sample and store said sample second reference output signal, the third GND1 level being lower than the fourth GND1 level.

4. The image sensor of claim 3, wherein the first GND1 level is above the second GND1 level as much as the fourth GND1 level is above the third GND1 level.

5. The image sensor of claim 1, wherein said control circuit has a configuration to switch said output transistor to provide a sampled light response output signal and to subsequently switch said reset transistor into a triode region such that said output transistor provides a sampled second reference output signal that is within 50 mV of the sampled reset output signal.

6. The image sensor of claim 5, wherein the sampled second reference output signal is lower than the sampled first reference output signal.
